(19) United States
(12) Patent Application Publication
(10) Pub. No.: US 2024/0029586 A1
(43) Pub. Date: Jan. 25, 2024

(54) VASCULAR LESION MODEL

(71) Applicant: ASAHI INTECC CO., LTD., Seto-shi (JP)

(72) Inventor: Kazu TAKEMURA, Seto-shi (JP)

(73) Assignee: ASAHI INTECC CO., LTD., Seto-shi (JP)

(21) Appl. No.: 18/370,093

(22) Filed: Sep. 19, 2023

Related U.S. Application Data
(63) Continuation of application No. PCT/JP2021/013871, filed on Mar. 31, 2021.

(51) Int. Cl. G09B 23/30

(52) U.S. Cl. CPC G09B 23/30

(57) ABSTRACT

A vascular lesion model includes a first lesion portion formed of a polymer material, and a second lesion portion provided in contact with the first lesion portion. A part of the second lesion portion including a surface in contact with the first lesion portion is formed of a material having an acoustic impedance higher than an acoustic impedance of the first lesion portion, and the second lesion portion simulates a calcified lesion in an ultrasonic image.

### CROSS-REFERENCE TO RELATED APPLICATION

This is a Continuation of Application No. PCT/JP2021/013871 filed Mar. 31, 2021. The disclosure of the prior application is hereby incorporated by reference herein in its entirety.

### TECHNICAL FIELD

The present disclosure relates to a vascular lesion model.

### BACKGROUND

Conventionally, various vascular lesion models are known. For example, Patent Literature 1 discloses a technique for producing a three-dimensional model of a blood vessel by lamination forming using a material such as a photocurable resin with reference to three-dimensional image data of the blood vessel. By using three-dimensional image data, a three-dimensional model having a three-dimensional shape in which a lesion such as plaque is formed in a blood vessel can be produced.

### CITATION LIST

### Patent Literature

Patent Literature 1: JP 2016-143034 A

### SUMMARY

### Technical Problem

However, the three-dimensional model as described above is not suitable for observation under ultrasound guidance. In recent years, methods using medical devices such as catheters, for example, percutaneous transluminal angioplasty (PTA) have been performed as methods for treating constriction and occlusion of blood vessels. Prior to such treatment, diagnosis may be made by observation under ultrasound guidance. Further, for example, patients who are allergic to contrast medium are desired to undergo treatment such as percutaneous transluminal angioplasty under ultrasound guidance. Therefore, a vascular lesion model has been desired by which it is possible to obtain an image simulating an ultrasonic image of an actual lesion portion under ultrasound guidance, for example, for the training of operators who perform the diagnosis and treatment described above. However, no model that satisfies such requirements has been known in the past.

### Solution to Problem

The present disclosure can be realized in the following aspects.

(1) According to an aspect of the present disclosure, a vascular lesion model is provided. The vascular lesion model includes a first lesion portion formed of a polymer material, and a second lesion portion provided in contact with the first lesion portion, in which a part of the second lesion portion including a surface in contact with the first lesion portion is formed of a material having an acoustic impedance higher than an acoustic impedance of the first lesion portion, and the second lesion portion simulates a calcified lesion in an ultrasonic image.

According to the vascular lesion model of the aspect, the second lesion portion is formed of a material having a higher acoustic impedance than the first lesion portion, and a calcified lesion is simulated by the second lesion portion in an ultrasonic image. Therefore, if such a vascular lesion model is used, it is possible to perform training for, e.g. treatment such as percutaneous transluminal angioplasty or observation of blood vessels with the purpose of diagnosis or the like, while obtaining an image simulating an ultrasonic image of an actual lesion portion under ultrasound guidance.

(2) In the vascular lesion model of the aspect described above, the second lesion portion may include calcium sulfate. According to such a configuration, a difference in acoustic impedance between the second lesion portion and the first lesion portion is ensured, and a calcified lesion can be easily simulated by the second lesion portion in an ultrasonic image. Further, by forming the second lesion portion using calcium sulfate, it becomes easy to bring the hardness of the second lesion portion closer to the hardness of the actual calcified lesion.

(3) In the vascular lesion model of the aspect described above, the second lesion portion may include calcium sulfate formed into granules. According to such a configuration, it becomes easy to obtain an ultrasonic image that is close to the ultrasonic image of an actual calcified lesion that is often formed as part of a lesion. Further, because the second lesion portion includes calcium sulfate formed into granules, it becomes easy to bring the hardness of the second lesion portion closer to the hardness of the actual calcified lesion. In addition, because the second lesion portion includes calcium sulfate formed into granules, it is possible to suppress darkening of the ultrasonic image due to attenuation of ultrasonic waves caused by being reflected by the second lesion portion, and thus make the ultrasonic image clearer.

(4) In the vascular lesion model of the aspect described above, the second lesion portion may include paraffin. According to such a configuration, a difference in acoustic impedance between the second lesion portion and the first lesion portion is ensured, and a calcified lesion can be easily simulated by the second lesion portion in an ultrasonic image. Further, by forming the second lesion portion using paraffin, it becomes easy to bring the hardness of the second lesion portion closer to the hardness of the actual calcified lesion.

(5) In the vascular lesion model of the aspect described above, the second lesion portion may include granules of a polymer material coated with paraffin. According to such a configuration, it becomes easy to obtain an ultrasonic image that is close to the ultrasonic image of an actual calcified lesion that is often formed as part of a lesion. In addition, because the second lesion portion includes granules of a polymer material coated with paraffin, it is possible to suppress darkening of the ultrasonic image due to attenuation of ultrasonic waves caused by being reflected by the second lesion portion, and thus make the ultrasonic image clearer.

(6) In the vascular lesion model of the aspect described above, the second lesion portion may include flakes of paraffin. According to such a configuration, by ensuring a difference in acoustic impedance from the first lesion portion, it is possible to suppress the attenuation of ultrasonic waves caused by the second lesion portion, while simulating a calcified lesion by the second lesion portion in the ultrasonic image. Moreover, it becomes easy to adjust the thickness of the paraffin included in the second lesion portion.

(7) In the vascular lesion model of the aspect described above, the first lesion portion may be formed of hydrogel. According to such a configuration, it becomes easy to suppress the acoustic impedance of the first lesion portion and ensure a difference in acoustic impedance between the first lesion portion and the second lesion portion. In addition, it becomes easy to bring the hardness of the first lesion portion closer to the hardness of plaque lesions other than calcified lesions.

(8) In the vascular lesion model of the aspect described above, the hydrogel may include a polysaccharide hydrogel. According to such a configuration, the polymer material forming the first lesion portion can be easily handled, and the first lesion portion including a hydrogel using water as a solvent can be easily produced.

(9) In the vascular lesion model of the aspect described above, the polysaccharide hydrogel may be an agarose gel. According to such a configuration, adjustment of softness of the first lesion portion can be facilitated.

(10) The vascular lesion model of the aspect described above may further include a blood vessel portion having a tubular shape, and the first lesion portion and the second lesion portion may be arranged inside the blood vessel portion to constrict or occlude the blood vessel portion. According to such a configuration, it is possible to enhance the sense of immersion in training by using the above-described vascular lesion model when performing training related to treatment or diagnosis under ultrasound guidance.

The present disclosure can be realized in various aspects other than the ones described above. For example, the present disclosure can be realized in aspects such as a method of manufacturing a vascular lesion model, an organ model including a vascular lesion model, and a human body simulation apparatus including a vascular lesion model.

### BRIEF DESCRIPTION OF DRAWINGS

FIG. 1 is a cross-sectional view schematically illustrating an overall configuration of a vascular lesion model according to a first embodiment.

FIG. 2 is a flowchart illustrating a method of manufacturing the vascular lesion model.

FIG. 3 is a flowchart illustrating a method of manufacturing a second lesion portion according to the first embodiment.

FIG. 4 is an explanatory view representing a photographed appearance of the vascular lesion model according to the first embodiment.

FIG. 5 is an explanatory view representing an ultrasonic image of the vascular lesion model according to the first embodiment.

FIG. 6 is a flowchart illustrating another example of a method of manufacturing the vascular lesion model.

FIG. 7 is a cross-sectional view schematically illustrating an overall configuration of a vascular lesion model according to a second embodiment.

FIG. 8 is a flowchart illustrating a method of manufacturing the second lesion portion according to the second embodiment.

FIG. 9 is an explanatory view representing a photographed appearance of the vascular lesion model according to the second embodiment.

FIG. 10 is an explanatory view representing an ultrasonic image of the vascular lesion model according to the second embodiment.

FIG. 11 is a cross-sectional view schematically illustrating an overall configuration of a vascular lesion model according to a third embodiment.

FIG. 12 is a flowchart illustrating a method of manufacturing the second lesion portion according to the third embodiment.

FIG. 13 is an explanatory view representing an ultrasonic image of the vascular lesion model according to the third embodiment.

FIG. 14 is an explanatory view representing an ultrasonic image of the vascular lesion model according to the third embodiment.

FIG. 15 is a cross-sectional view schematically illustrating an overall configuration of a vascular lesion model according to a fourth embodiment.

FIG. 16 is a flowchart illustrating a method of manufacturing the vascular lesion model according to the fourth embodiment.

FIG. 17 is an explanatory view representing a photographed appearance of the vascular lesion model according to the fourth embodiment.

FIG. 18 is an explanatory view representing an ultrasonic image of the vascular lesion model according to the fourth embodiment.

FIG. 19 is an explanatory view representing a photographed appearance of the vascular lesion model according to the fourth embodiment.

FIG. 20 is an explanatory view representing an ultrasonic image of the vascular lesion model according to the fourth embodiment.

FIG. 21 is a cross-sectional view schematically illustrating an overall configuration of a vascular lesion model according to a variation of the fourth embodiment.

### DETAILED DESCRIPTION OF EMBODIMENTS

### A. First Embodiment

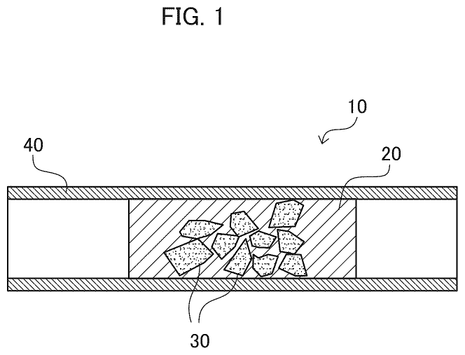

FIG. 1 is a cross-sectional view schematically illustrating an overall configuration of a vascular lesion model 10 according to a first embodiment. The vascular lesion model 10 according to the present embodiment is used to simulate treatment or examination procedures for blood vessels using medical devices under ultrasound guidance. The vascular lesion model 10 includes a first lesion portion 20, a second lesion portion 30, and a blood vessel portion 40 in which the first lesion portion and the second lesion portion 30 are arranged.

The first lesion portion 20 is formed of a polymer material, and simulates a lesion portion excluding a calcified site in an ultrasonic image including plaque being a lesion portion in a blood vessel. Specifically, as described later, the first lesion portion has a lower acoustic impedance than the second lesion portion 30, and is observed as being relatively dark in the ultrasonic image, thereby simulating the lesion portion excluding the calcified lesion. It is desirable that the polymer material forming the first lesion portion 20 easily transmits ultrasonic waves so that it is possible to suppress the attenuation of ultrasonic waves caused by the first lesion portion 20. As a result, when performing training using a medical device such as a catheter or a guide wire together with the vascular lesion model 10 under ultrasound guidance, it becomes easy to observe the medical device inserted into the vascular lesion model in the ultrasonic image.

As the polymer material forming the first lesion portion 20, it is desirable to use, for example, a hydrogel containing a large amount of water, from the viewpoint that such material has a relatively low acoustic impedance and relatively easily transmits ultrasonic waves. Examples of hydrogels used to form the first lesion portion 20 include polysaccharide hydrogels such as agarose gel, methylcellulose gel, hyaluronic acid hydrogel, alginate hydrogel, carboxymethylcellulose gel, and xanthan gum. Protein hydrogels containing collagen, gelatin, albumin, or keratin, etc.; synthetic polymer hydrogels including polyethylene glycol (PEG), polylactic acid, or polyacrylic acid, etc.; polyvinyl alcohol (PVA) hydrogels; and silicone hydrogels may also be used. Alternatively, the first lesion portion 20 may be formed of a polymeric material other than hydrogel, such as urethane gel. The first lesion portion 20 may be formed by combining any two or more of various polymer materials as described above. Among the polymer materials described above, polysaccharide hydrogels and polyvinyl alcohol are preferable because they are easy to handle, and agarose is particularly preferable because of the ease of softness adjustment. The concentration of the polymer material in the first lesion portion 20 may be appropriately set according to desired physical properties such as the hardness to be achieved in the first lesion portion 20.

In addition to the polymer material described above, the first lesion portion 20 may further contain fine particles or nanofibers, as a reflector that reflects ultrasonic waves. The reflector may be formed of a material having an acoustic impedance higher than that of the polymeric material forming the first lesion portion 20. By mixing a fine particulate or nanofiber reflector with the polymer material and dispersing in the first lesion portion 20, it is possible to adjust the brightness of the first lesion portion 20 in the ultrasonic image, and bring the ultrasonic image closer to an actual image for a living body. As a reflector, for example, it is possible to use cellulose nanofiber (CNF). When fine particles are used as the reflector, it is desirable that fine particles with a particle size that is about the same as that of the nanofiber, for example, about 10 nm or more and several hundred nm or less are used to uniformly adjust the brightness of the section of the first lesion portion 20 in the ultrasonic image.

The second lesion portion 30 is provided in contact with the first lesion portion 20, is formed of a material having a higher acoustic impedance than the first lesion portion 20, and simulates a calcified lesion in the ultrasonic image. In the present embodiment, the second lesion portion 30 is formed into granules using calcium sulfate (as a hemihydrate, dihydrate, or anhydride). Calcium sulfate is readily available as a single substance in the form of a powder. Therefore, to obtain the second lesion portion 30 having an arbitrary shape, for example, calcium sulfate in the form of a powder may be mixed with a material that can be used as a solvent such as water or a gel material (such as agarose gel, gelatin gel, polyvinyl alcohol (PVA) gel, urethane gel, and silicone gel), and the calcium sulfate may be formed into a desired shape, such as granules.

The blood vessel portion 40 is a portion simulating a human blood vessel and has a hollow tubular shape. The blood vessel portion 40 may be formed of a material that sufficiently transmits ultrasonic waves so that the first lesion portion 20 and the second lesion portion 30 arranged in the blood vessel portion 40 can be observed under ultrasonic irradiation. The blood vessel portion 40 is desirably formed of a transparent or translucent material so that the state of the first lesion portion 20 and the second lesion portion 30 arranged inside the blood vessel portion 40 can be visually recognized from the outside. Further, the blood vessel portion 40 is desirably formed of a resin material by which it is easy to obtain a tactile sensation similar to that of a human blood vessel when being touched via a medical device such as a catheter or a guide wire. Examples of materials that can be used to form the blood vessel portion 40 include polyvinyl alcohol (PVA), agarose, sodium alginate, cellulose, starch, glycogen, silicone, latex, and polyurethane. Among these materials, polyvinyl alcohol (PVA) is desirable, because the slidability and the elasticity of PVA are similar to those of a human blood vessel. If the softness, the slidability, the elasticity, and the like of the blood vessel portion 40 are designed similar to those of a human blood vessel, it is possible to enhance the immersive feeling of an operator who trains a procedure related to treatment and diagnosis using the vascular lesion model 10. It is noted that the inner diameter and the outer diameter of the blood vessel portion 40 and the length of the blood vessel portion 40 in the longitudinal direction can be freely selected according to the type of blood vessel to be simulated, the type of procedure to be trained, and the like.

In the present embodiment, the second lesion portion 30 being an aggregate of granular calcium sulfate is embedded in the first lesion portion 20, so that the first lesion portion 20 and the second lesion portion 30 are provided in contact with each other. The first lesion portion 20 and the second lesion portion 30 are arranged in the blood vessel portion 40 to simulate the state of constriction or occlusion of the blood vessel by the lesion portion. FIG. 1 illustrates the state in which the first lesion portion 20 and the second lesion portion 30 are arranged to block the inside of the blood vessel portion 40.

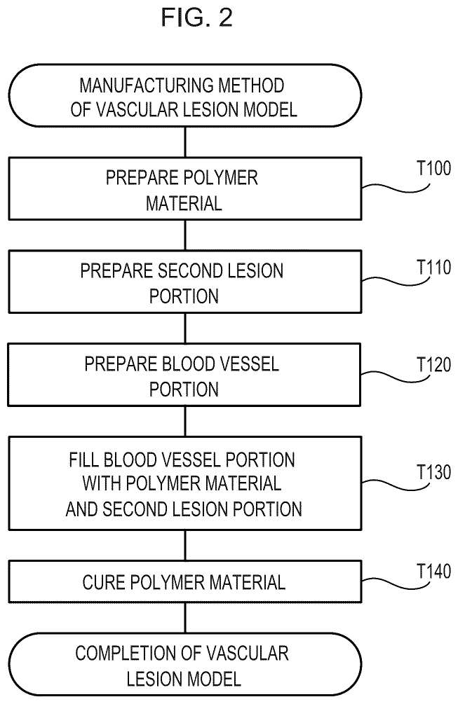

FIG. 2 is a flowchart illustrating a method of manufacturing the vascular lesion model 10. To manufacture the vascular lesion model 10, first, a polymer material for forming the first lesion portion 20 is prepared (step T100). Specifically, for example, if agarose is used as a polymer material, agarose being a polymer material, and, if necessary, a reflector such as cellulose nanofiber (CNF) are mixed in a solvent such as water to obtain an aqueous agarose solution being a solution of the polymer material. In step T100, heating may be performed as necessary to obtain a solution of the polymer material. In addition, the second lesion portion 30 is prepared separately from the above-described polymer material (step T110). A method of manufacturing the second lesion portion 30 prepared in step T110 will be described below.

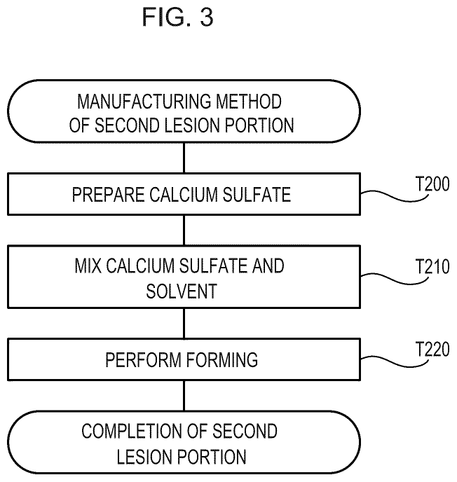

FIG. 3 is a flowchart illustrating a method of manufacturing the second lesion portion 30. To manufacture the second lesion portion 30, first, calcium sulfate is prepared (step T200). In step T200, for example, calcium sulfate in the form of a powder may be prepared. Then, the calcium sulfate prepared in step T200 is mixed with the above-described solvent (step T210), and formed into any size and shape (step T220) to obtain the second lesion portion 30. Any of calcium sulfate hemihydrate, calcium sulfate dihydrate, and anhydrous calcium sulfate may be used as described above. However, for example, when, in step T200, calcium sulfate hemihydrate is prepared, and, in step T210, is mixed with water as a solvent, calcium sulfate becomes a dihydrate and easily solidifies. After solidification, the granular second lesion portion 30 can be obtained by cutting or crushing to any size. In addition, when polyvinyl alcohol (PVA) is used as the solvent in step T210, it is desirable to use calcium sulfate dihydrate, because anhydrous calcium sulfate is insoluble in PVA and it is difficult to sufficiently mix anhydrous calcium sulfate with PVA. It is noted that the material of the second lesion portion 30 to be prepared in step T200 may contain a material other than calcium sulfate, as long as effect on an ultrasonic image of the vascular lesion model 10 is within an allowable range.

Returning to FIG. 2, once the second lesion portion 30 is manufactured in step T110, next, a tubular member that will become the blood vessel portion 40 is prepared (step T120). The blood vessel portion 40 is filled with the solution of the polymer material prepared in step T100 and the second lesion portion 30 manufactured in step T110 (step T130). Then, the polymer material is cured (step T140) to complete the vascular lesion model 10. For example, when an aqueous agarose solution is prepared as the polymeric material in step T100, the aqueous agarose solution and the granular second lesion portion 30 are mixed and the blood vessel portion 40 is filled with the mixture in step T130. Then, in step T140, the agarose solution is cured into an agarose gel. In step T140, cooling may be performed as necessary.

The vascular lesion model 10 may be directly used for training under ultrasound guidance, or may be used while being immersed into a fluid (for example, simulated blood such as physiological saline). Alternatively, if the lesion portion does not occlude the blood vessel portion 40 in the vascular lesion model 10, a flow path for a fluid (for example, simulated blood such as physiological saline) may be connected to the vascular lesion model 10 to circulate the fluid in the flow path including the blood vessel portion 40. The vascular lesion model 10 may be incorporated into an organ model simulating an organ such as a heart, liver, or brain, together with a blood vessel model that does not include a lesion portion. Alternatively, the vascular lesion model may be incorporated into a human body simulation apparatus that simulates at least a part of a human body, together with a blood vessel model and an organ model that do not include a lesion portion.

According to the vascular lesion model 10 of the first embodiment formed as described above, the second lesion portion 30 is formed using calcium sulfate being an inorganic material, and thus the second lesion portion 30 has a higher acoustic impedance than the first lesion portion 20 formed of a polymer material such as hydrogel. Thus, as a result of forming the second lesion portion 30 provided in contact with the first lesion portion 20 with a material having a higher acoustic impedance than the first lesion portion 20, the second lesion portion 30 simulates a calcified lesion in the ultrasonic image. Specifically, the first lesion portion with a lower acoustic impedance is observed as being relatively dark in the ultrasonic image, and simulates a plaque lesion excluding a calcified site. The second lesion portion 30 formed of calcium sulfate reflects ultrasonic waves due to the difference in acoustic impedance from the first lesion portion 20 arranged in contact with the second lesion portion 30, and thus the second lesion portion 30 is observed as being white in the ultrasonic image and simulates a calcified lesion in the ultrasonic image. Therefore, if the vascular lesion model 10 of the present embodiment is used, it is possible to perform training for, e.g. treatment such as percutaneous transluminal angioplasty or observation of blood vessels with the purpose of diagnosis or the like, while obtaining an image simulating an ultrasonic image of an actual lesion portion under ultrasound guidance.

In particular, in the present embodiment, the second lesion portion 30 is formed using calcium sulfate, and therefore, a difference in acoustic impedance between the second lesion portion 30 and the first lesion portion 20 is ensured, and a calcified lesion can be easily simulated by the second lesion portion 30 in the ultrasonic image. Further, by forming the second lesion portion 30 using calcium sulfate, it becomes easy to bring the hardness of the second lesion portion 30 closer to the hardness of the actual calcified lesion. At this time, the hardness of the second lesion portion 30 can be adjusted by appropriately selecting calcium sulfate for forming the second lesion portion 30, from calcium sulfate hemihydrate, calcium sulfate dihydrate, and anhydrous calcium sulfate. For example, by using calcium sulfate dihydrate, the hardness of the second lesion portion 30 can be softened compared to when calcium sulfate hemihydrate is used. Further, by forming the second lesion portion 30 using calcium sulfate, for example, as described above, it is possible to easily form the second lesion portion 30 by mixing water with calcium sulfate hemihydrate and solidifying the mixture.

The acoustic impedance is a specific acoustic impedance, and can be determined by multiplying the density of an object with the speed of sound (the speed of sound waves propagating through the object). The speed of sound of the object can be determined by, for example, the pulse echo method.

In addition, actual calcified lesions are often formed as a part of the lesion rather than an entire lesion formed in the blood vessel. Therefore, when an aggregate of the granular second lesion portion 30 is arranged in the first lesion portion 20 formed of a polymer material, it becomes easy to obtain an image close to an actual vascular lesion in an ultrasonic image.

In the present embodiment, when the second lesion portion 30 is an aggregate of granules formed using calcium sulfate, it becomes easy to bring the hardness of the second lesion portion 30 closer to that of the actual calcified lesion. Therefore, when performing training using a medical device such as a guide wire together with the vascular lesion model 10, the feeling when the wire or the like comes into contact with the second lesion portion 30, the feeling of breaking the second lesion portion 30 when the wire is pushed into the second lesion portion 30, and the like can easily be brought closer to that for an actual calcified lesion, and the operator's sense of immersion during training can be enhanced.

Furthermore, when the second lesion portion 30 is an aggregate of granules formed using calcium sulfate, a part of the ultrasonic waves can pass in between the granules forming the second lesion portion 30 without being reflected on the surface of the second lesion portion 30. Therefore, it is possible to suppress darkening of the ultrasonic image due to attenuation of ultrasonic waves caused by being reflected by the second lesion portion 30. As a result, when performing training using a medical device such as a catheter or a guide wire together with the vascular lesion model 10 under ultrasound guidance, it becomes easy to observe the medical device inserted into the vascular lesion model in the ultrasonic image as the ultrasonic image becomes clearer.

When the second lesion portion 30 is an aggregate of granules formed using calcium sulfate, it becomes particularly easy to simulate calcified lesions in relatively long and thick blood vessels such as arteries of the lower extremities. That is, in relatively long and thick blood vessels such as arteries of the lower extremities, calcified lesions can be randomly formed over a wide range, and, to simulate the state of such blood vessels, a certain quantity of lesion portions having certain sizes is required as the lesion portions for simulating calcified lesions. As in the present embodiment, when the second lesion portion 30 is an aggregate of granules formed using calcium sulfate, calcified lesion portions having any sizes can be placed at any positions within the blood vessel portion 40 and can be embedded in the first lesion portion 20, because of which the calcified lesions can be easily simulated. As a result, the process for manufacturing such a vascular lesion model 10 can be shortened, and an effect of facilitating mass-production of the vascular lesion model 10 can be achieved.

When calcium sulfate is formed into granules, the particle size (the maximum value of the distance between points on the outer periphery of a particle in the particle cross section) can be appropriately set according to the inner diameter of the blood vessel portion 40, the feeling desired when the medical device is brought into contact with the second lesion portion 30, the extent of attenuation of ultrasonic waves in the ultrasonic image, and the like. The particle size of the calcium sulfate granules is preferably 1 mm or more, more preferably 2 mm or more, for example, from the viewpoint of suppressing attenuation of ultrasonic waves. Moreover, the particle size of the calcium sulfate granules is preferably 8 mm or less, more preferably 6 mm or less, for example, from the viewpoint of bringing the feeling when the medical device is brought into contact with the second lesion portion 30 closer to that for an actual calcified lesion. It is noted that, when the second lesion portion 30 is formed using calcium sulfate, the shape of the second lesion portion 30 may be a shape other than the granular shape described above, for example, calcium sulfate in the form of a powder may be dispersed in the first lesion portion 20.

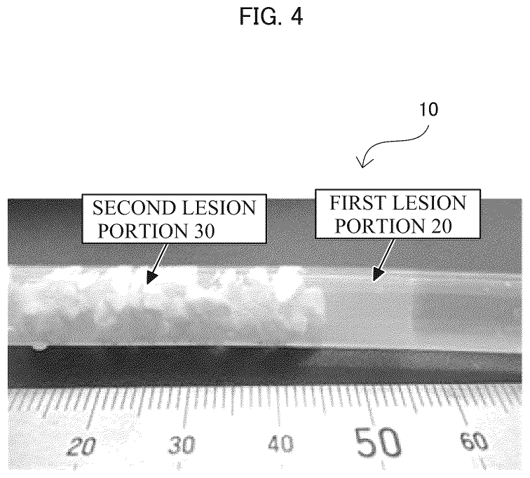

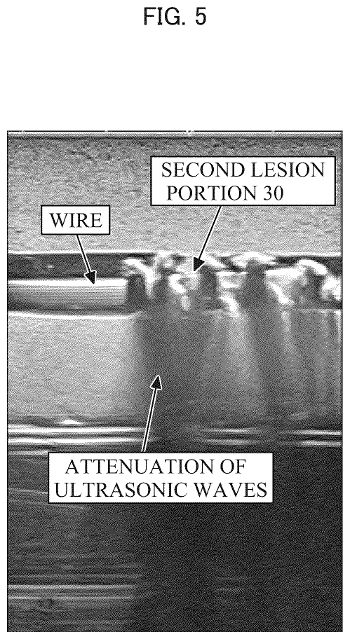

FIG. 4 is an explanatory view representing a photographed appearance of the vascular lesion model 10 including the granular second lesion portion 30 manufactured by the method of manufacturing illustrated in FIGS. 2 and 3. FIG. 5 is an explanatory view representing an ultrasonic image of the vascular lesion model 10 similar to FIG. 4. FIG. 5 illustrates the state of insertion of a wire as a medical device into the vascular lesion model 10. Here, agarose gel mixed with cellulose nanofibers (CNF) is used as the polymer material forming the first lesion portion 20. As shown in FIG. 5, the surroundings of the second lesion portion 30 can easily be observed. This is because the second lesion portion 30, which has a higher acoustic impedance than the first lesion portion 20 and appears white by reflecting the ultrasonic waves, is formed into granules, and thus the ultrasonic waves pass through the gaps between the granules.

In FIG. 2, a method of manufacturing a vascular lesion model having a lesion portion that occludes a blood vessel has been described, however, as described above, in addition to occlusion of the blood vessel by the lesion portion, the vascular lesion model may be in a state of constriction rather than being occluded. As a variation, an example of a method of manufacturing a vascular lesion model in which the lesion portion constricts the blood vessel portion 40 without occluding the blood vessel portion will be described below.

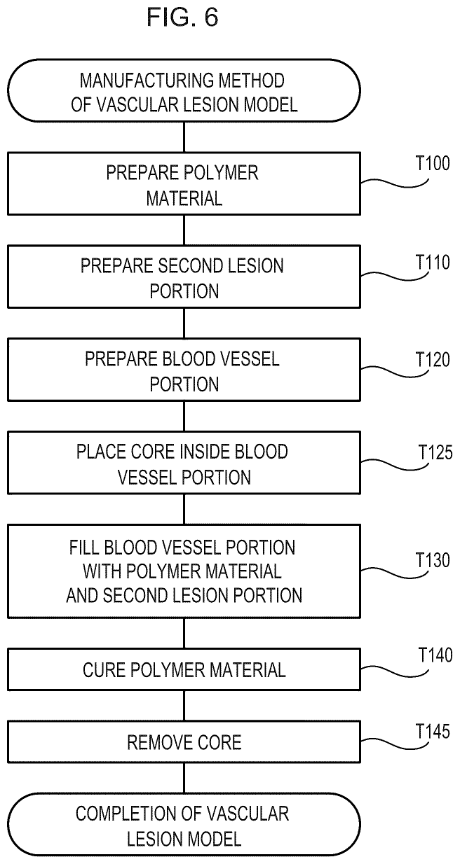

FIG. 6 is a flowchart illustrating another example of a method of manufacturing the vascular lesion model 10 according to the first embodiment. In FIG. 6, the same step numbers are assigned to the steps common to those in FIG. 2. Also in FIG. 6, similar to FIG. 2, first, a polymer material for forming the first lesion portion 20, the second lesion portion 30, and the blood vessel portion 40 are prepared (steps T100 to T120). Then, a core is placed inside the blood vessel portion 40 (step T125). The core used in step T125 is for forming a space that is not occluded by the lesion portion in the vascular lesion model, and is formed of a rod-like member having a smaller diameter than the inner diameter of the blood vessel portion 40. For example, the above-described core can be made of metal, because metal has the rigidity to hold a position for forming a space in the blood vessel portion 40.

After placing the core in the blood vessel portion 40 in step T125, the space around the core in the blood vessel portion 40 is filled with a solution of the polymer material and the second lesion portion 30 (step T130), and the polymer material is cured (step T140). Following this, the core is removed from inside the blood vessel portion (step T145), and the vascular lesion model 10 is completed. As a result, the vascular lesion model 10 that is in a state of constriction by the lesion portion can be obtained. Further, to facilitate the removal of the core in step T145, it is also desirable to apply a surface treatment to the core to improve the releasability.

### B. Second Embodiment

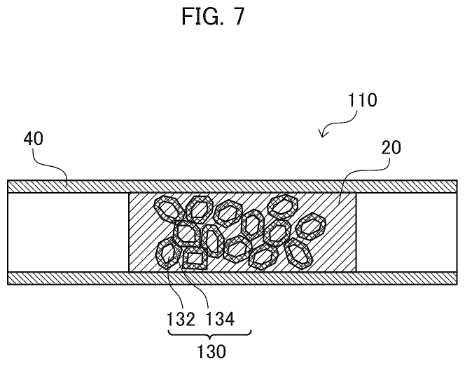

FIG. 7 is a cross-sectional view schematically illustrating an overall configuration of a vascular lesion model 110 according to a second embodiment. In the vascular lesion model 110 of the second embodiment, parts common to the vascular lesion model 10 of the first embodiment are given the same reference numerals. As in FIG. 1, FIG. 7 illustrates a state in which the blood vessel portion 40 is occluded by a lesion portion, but the model may also be one in which the blood vessel portion 40 is constricted without being occluded by a lesion portion.

Similar to the vascular lesion model 10 of the first embodiment, the vascular lesion model 110 includes the first lesion portion 20 and the blood vessel portion 40, but instead of the second lesion portion 30, the vascular lesion model 110 includes a second lesion portion 130. The second lesion portion 130 includes granular portions 132 formed of a polymeric material, and a coat layer 134 formed of paraffin and provided to cover the surfaces of the granular portions 132.

The granular portions 132 can be formed of a polymeric material similar to the material of the first lesion portion 20. That is, as the polymer material forming the granular portions 132, for example, one or more types among hydrogels such as polysaccharide hydrogel, protein hydrogel, synthetic polymer hydrogel, polyvinyl alcohol (PVA) hydrogel, and silicone hydrogel, and urethane gel or the like can be used. In addition to the polymer material as described above, the granular portions 132 may further contain fine particles or nanofibers, as a reflector that reflects ultrasonic waves. The granular portions 132 may be formed of a material having the same composition as that of the first lesion portion 20, or may be formed of a material having a different composition.

The coating layer 134 can be formed of paraffin alone or paraffin to which stearic acid has been added. By adding stearic acid to paraffin so that the stearic acid content is, for example, about 3 to 10 weight percent of the total, generation of air bubbles in paraffin can be suppressed, or the hardness of paraffin can be increased. In addition, the coating layer may be a mixture of paraffin and other materials other than stearic acid as long as the influence on the acoustic impedance is within an allowable range.

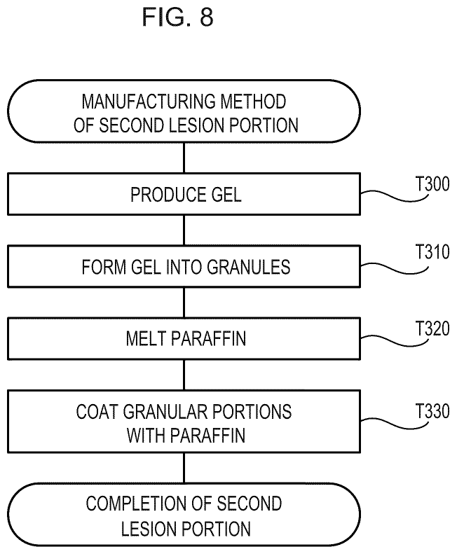

FIG. 8 is a flowchart illustrating a method of manufacturing the second lesion portion 130 according to the second embodiment. The vascular lesion model 110 of the second embodiment can be manufactured by the method illustrated in FIG. 2 or FIG. 6 as in the first embodiment. FIG. 8 illustrates a process corresponding to step T110 in FIG. 2 or FIG. 6.

When manufacturing the second lesion portion 130, first, a gel for forming the granular portions 132 is produced (step T300). For example, when agarose is used as the polymer material and cellulose nanofibers (CNF) are used as the reflector, the agarose may be mixed with water and the cellulose nanofibers to dissolve the agarose in the water, and then the agarose may be cured to produce an agarose gel. After that, the gel produced in step T300 is shaped into granules to form the granular portions 132 (step T310). In step T310, for example, the gel produced in step T300 may be cut into a desired size such as 5 mm or less.

Separately from the agarose gel described above, a paraffin-containing material for forming the coating layer 134 is prepared and mixed, and the paraffin in this material is melted (step T320). Paraffin can be easily melted by heating to 60° C. or above. In step T320, materials other than paraffin may not be melted, and may be dispersed in molten paraffin. Then, the granular portions 132 obtained in step T310 are coated with paraffin (step T330) to complete the second lesion portion 130. The paraffin coating in step T330 can be performed, for example, by immersing the granular portions 132 in molten paraffin and then solidifying the molten paraffin adhering to the surface of the granular portions 132 at, for example, room temperature. During paraffin coating, cooling may be performed as necessary.

In the vascular lesion model 110 of the second embodiment formed as described above, in the second lesion portion 130, the coating layer 134 that is a part including the surface in contact with the first lesion portion 20 is formed using paraffin, because of which the acoustic impedance of the coating layer 134 is higher than that of the first lesion portion 20 formed of a polymer material such as hydrogel. Thus, as a result of forming the coating layer 134 provided in contact with the first lesion portion 20 with a material having a higher acoustic impedance than the first lesion portion 20, the second lesion portion 30 simulates a calcified lesion in the ultrasonic image. Specifically, the first lesion portion with a lower acoustic impedance is observed as being relatively dark in the ultrasonic image, and simulates a plaque lesion excluding a calcified site. The second lesion portion 130 covered by the coating layer 134 formed of paraffin reflects ultrasonic waves due to the difference in acoustic impedance from the first lesion portion 20 arranged in contact with the second lesion portion 130, and thus the second lesion portion 130 is observed as being white in the ultrasonic image and simulates a calcified lesion in the ultrasonic image. Therefore, if the vascular lesion model 110 of the present embodiment is used, it is possible to perform training for, e.g. treatment such as percutaneous transluminal angioplasty or observation of blood vessels with the purpose of diagnosis or the like, while obtaining an image simulating an ultrasonic image of an actual lesion portion under ultrasound guidance.

In particular, the coating layer 134 of the second lesion portion 130 is formed using paraffin, and therefore, a difference in acoustic impedance between the second lesion portion 130 and the first lesion portion 20 is ensured, and a calcified lesion can be easily simulated by the second lesion portion 130 in the ultrasonic image. Further, by forming the coating layer 134 using paraffin, it becomes easy to bring the hardness of the second lesion portion 130 closer to the hardness of the actual calcified lesion. In addition, by arranging an aggregate of the granular second lesion portion 130 in the first lesion portion 20 formed of the polymer material, it becomes easy to obtain an ultrasonic image close to an actual calcified lesion formed as a part of a lesion portion.

Moreover, the second lesion portion 130 is an aggregate of granules coated with paraffin, because of which it becomes easy to bring the hardness of the second lesion portion 130 closer to that of the actual calcified lesion. Therefore, when performing training using a medical device such as a guide wire together with the vascular lesion model 110, the feeling when the wire or the like comes into contact with the second lesion portion 130, and the feeling of breaking the second lesion portion 130 when the wire is pushed into the second lesion portion 130 can easily be brought closer to that for an actual calcified lesion, and the operator's sense of immersion during training can be enhanced. Furthermore, the second lesion portion 130 is an aggregate of granules, and therefore, a part of the ultrasonic waves can pass in between the granules forming the second lesion portion 130 without being reflected on the surface of the second lesion portion 130. Therefore, it is possible to suppress the attenuation of ultrasonic waves caused by being reflected by the second lesion portion 130, and when performing training using a medical device under ultrasound guidance, it becomes easy to observe the medical device inserted into the vascular lesion model in the ultrasonic image. By forming the second lesion portion 30 as an aggregate of granules, a calcified lesion portion of any size can be placed at any position within the blood vessel portion 40 and can be embedded in the first lesion portion 20. Therefore, it becomes easy to simulate randomly formed calcified lesions in relatively long and thick blood vessels such as arteries of lower extremities. As a result, the process for manufacturing the vascular lesion model 110 can be shortened, and the vascular lesion model 110 can be easily mass-produced.

The paraffin forming the surface of the second lesion portion 130 in the present embodiment is insoluble in water. Therefore, even if the first lesion portion 20 and the granular portions 132 are formed using a gel such as agarose that uses water as a solvent, change in the second lesion portion 130 due to the moisture in the gel can be prevented.

Further, in the second lesion portion 130 of the present embodiment, the coating layer 134 including the surface is the only part that is formed using paraffin. Paraffin has a relatively high acoustic impedance, and such a high acoustic impedance results in a relatively high degree of reflection of ultrasonic waves, on the surface that contacts the first lesion portion 20. However, since the coating layer 134 is the only part that is formed using paraffin, the degree of reflection of ultrasonic waves on the surface of the second lesion portion 130 can be suppressed. As a result, it is possible to suppress the attenuation of ultrasonic waves caused by the reflection of the ultrasonic waves on the surface of the second lesion portion 130, and thus make the ultrasonic image clearer.

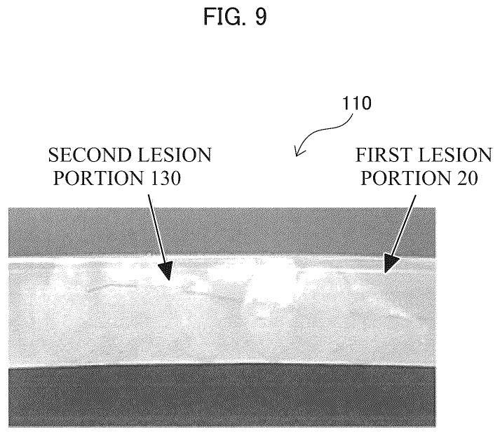

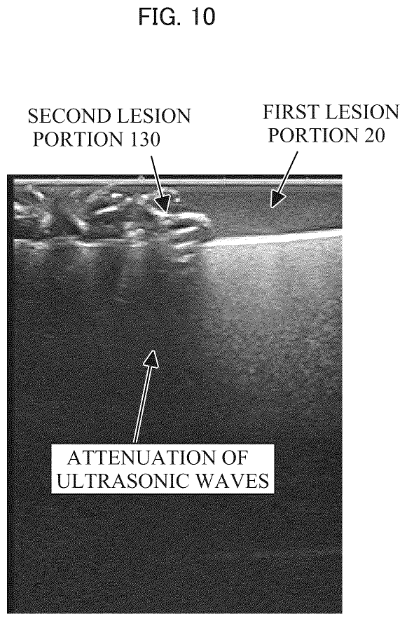

FIG. 9 is an explanatory view representing a photographed appearance of the vascular lesion model 110 including the granular second lesion portion 130 manufactured by the method of manufacturing illustrated in FIGS. 2 and 8. FIG. 10 is an explanatory view representing an ultrasonic image of the vascular lesion model 110 similar to FIG. 9. Here, agarose gel mixed with cellulose nanofibers (CNF) is used as the polymer material forming the first lesion portion 20 and the granular portion 132. As shown in FIG. 10, the surroundings of the second lesion portion 130 can easily be observed. This is because the second lesion portion 130, which has a higher acoustic impedance than the first lesion portion 20 and appears white by reflecting the ultrasonic waves, is formed into granules, and thus the ultrasonic waves pass through the gaps between the granules.

### C. Third Embodiment

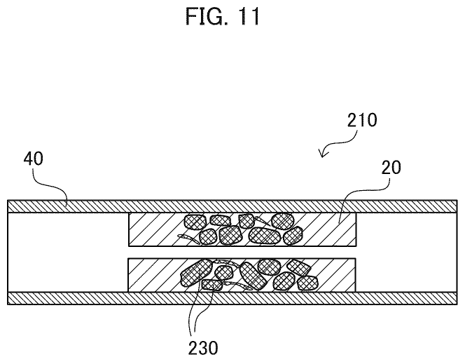

FIG. 11 is a cross-sectional view schematically illustrating an overall configuration of a vascular lesion model 210 according to a third embodiment. In the vascular lesion model 210 of the third embodiment, parts common to the vascular lesion model 10 of the first embodiment are given the same reference numerals. FIG. 11 illustrates a state in which the blood vessel portion 40 is constricted by a lesion portion without being occluded, but the model may also be one in which the blood vessel portion 40 is occluded by a lesion portion.

Similar to the vascular lesion model 10 of the first embodiment, the vascular lesion model 210 includes the first lesion portion 20 and the blood vessel portion 40, but instead of the second lesion portion 30, the vascular lesion model 110 includes a second lesion portion 230. The second lesion portion 230 is formed of flakes made of paraffin. The flakes being the second lesion portion 230 can be formed of paraffin alone or paraffin to which stearic acid has been added.

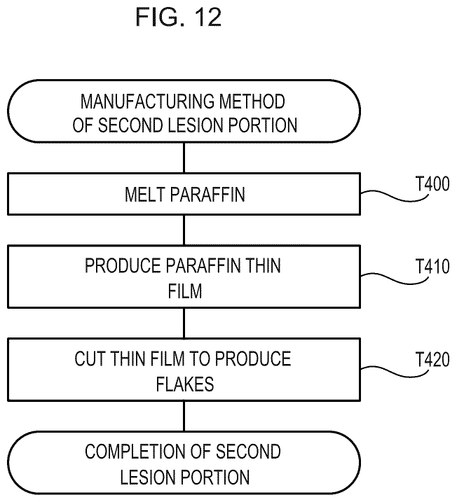

FIG. 12 is a flowchart illustrating a method of manufacturing the third lesion portion 130 according to the second embodiment. The vascular lesion model 110 of the third embodiment can be manufactured by the method illustrated in FIG. 2 or FIG. 6 as in the first embodiment. FIG. 12 illustrates a process corresponding to step T110 in FIG. 2 or FIG. 6.

When manufacturing the second lesion portion 230, first, a material containing paraffin for forming the second lesion portion 230 is prepared and the paraffin is melted (step T400). Then, a thin film is formed using the paraffin melted in step T400 (step T410). The thin film formation in step T410 may be performed, for example, by applying molten paraffin onto a substrate such as polytetrafluoroethylene (PTFE). The application of molten paraffin can be performed by, for example, a doctor blade method, a spray method, a dip coating method, or the like. From the viewpoint of ease of handling, for example, the thickness of the paraffin thin film is preferably 10 nm or more, more preferably 50 nm or more, and even more preferably 100 nm or more. From the viewpoint of suppressing attenuation of ultrasonic waves by the paraffin thin film, for example, the thickness of the paraffin thin film is preferably 1 mm or less, more preferably 800 nm or less, and even more preferably 500 nm or less. After step T410, the prepared paraffin thin film is cut into flakes (step T420) to complete the second lesion portion 230.

According to such a configuration, since the second lesion portion 230 formed using paraffin is provided, a similar effect to that of the second embodiment can be obtained. For example, it becomes easy to bring the hardness of the second lesion portion 130 closer to the actual calcified lesion. Alternatively, it becomes easy to simulate randomly formed calcified lesions in relatively long and thick blood vessels such as arteries of lower extremities. In addition, in the third embodiment, the second lesion portion 230 includes flakes of paraffin, and thus a difference in acoustic impedance from the first lesion portion 20 is ensured. Thus, it is possible to suppress the attenuation of ultrasonic waves caused by the second lesion portion 230, while simulating a calcified lesion by the second lesion portion 230 in the ultrasonic image. Furthermore, in the third embodiment, a thin film is produced using molten paraffin to produce the second lesion portion 230 in the form of flakes. By thus forming the thin film to produce the second lesion portion 230, the thickness of the paraffin forming the second lesion portion can be easily adjusted compared to a case where the granular portions 132 are coated with molten paraffin as in the second embodiment.

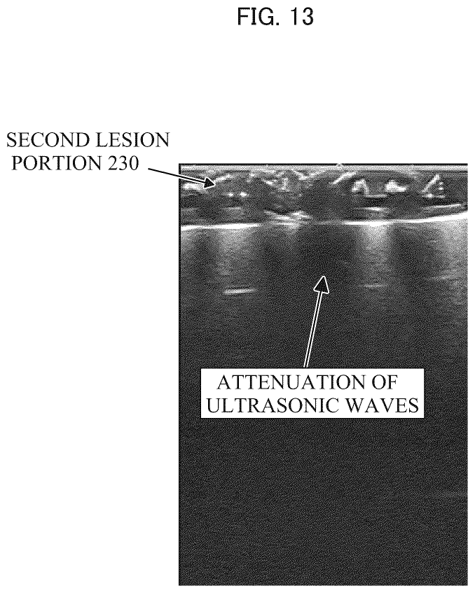

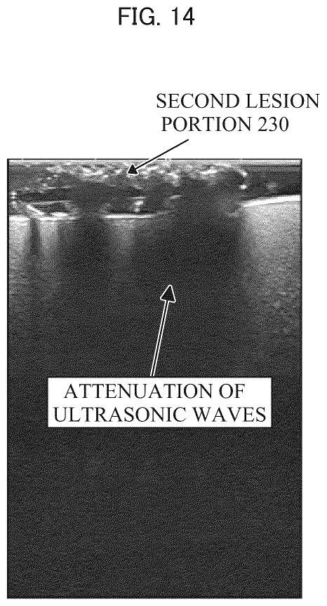

FIGS. 13 and 14 are explanatory views representing ultrasonic images of the vascular lesion model 210 including the second lesion portion 230 in the form of flakes manufactured by the method of manufacturing illustrated in FIGS. 6 and 12. FIG. 13 is an ultrasonic image of the vascular lesion model 210 having the second lesion portion 230 including flakes with a diameter of 3 or more and 5 mm or less (the maximum value of the distance between points on the outer periphery of a flake), and FIG. 14 is an ultrasonic image of the vascular lesion model 210 having the second lesion portion 230 including flakes with a diameter of 3 mm or less. Here, agarose gel mixed with cellulose nanofibers (CNF) is used as the polymer material forming the first lesion portion 20. As shown in FIGS. 13 and 14, the surroundings of the second lesion portion 230 can easily be observed. This is because the second lesion portion 230, which has a higher acoustic impedance than the first lesion portion 20 and appears white by reflecting the ultrasonic waves, is formed into flakes, and thus the ultrasonic waves pass through the gaps between the flakes. As can be understood by comparing FIGS. 13 and 14, the smaller the diameter of the flakes, the shorter the distance between the flakes and the easier it is for the ultrasonic waves to attenuate. From the above, it is understood that by appropriately adjusting the diameter of the flakes, the ultrasonic image can be brought closer to the desired image representing the calcified lesion.

### D. Fourth Embodiment

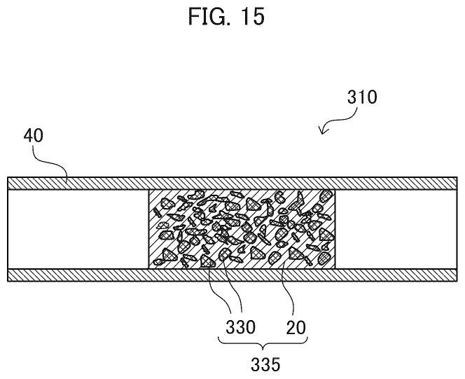

FIG. 15 is a cross-sectional view schematically illustrating an overall configuration of a vascular lesion model 310 according to a fourth embodiment. In the vascular lesion model 310 of the fourth embodiment, parts common to the vascular lesion model 10 of the first embodiment are given the same reference numerals. As in FIG. 1, FIG. 15 illustrates a state in which the blood vessel portion 40 is occluded by a lesion portion, but the model may also be one in which the blood vessel portion 40 is constricted without being occluded by a lesion portion.

Similar to the vascular lesion model 10 of the first embodiment, the vascular lesion model 310 includes the first lesion portion 20 and the blood vessel portion 40, but instead of the second lesion portion 30, the vascular lesion model 310 includes a second lesion portion 330. The second lesion portion 330 is formed by fine particles of paraffin dispersed in the first lesion portion 20 made of a polymer material. In the fourth embodiment, the structure in which the second lesion portion 330 is dispersed in the first lesion portion 20 is also called a mixed lesion portion 335.

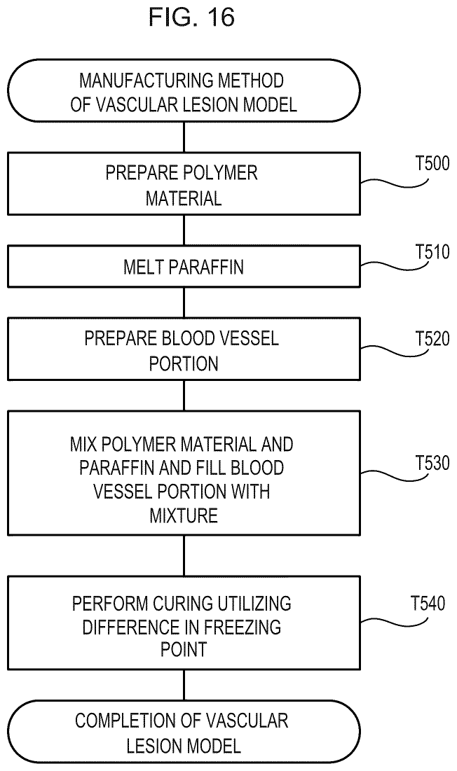

FIG. 16 is a flowchart illustrating a method of manufacturing the vascular lesion model 310 according to the fourth embodiment. Here, a method of manufacturing the vascular lesion model 310 having a lesion portion that occludes a blood vessel is illustrated. To manufacture the vascular lesion model 310, first, a polymer material for forming the first lesion portion 20 is prepared (step T500). This step is similar to step T100 in FIG. 2. Separately from the polymer material, paraffin for forming the second lesion portion 330 is melted (step T510) in the same manner as step T400 in FIG. 12. The paraffin melted in step T510 can be, for example, paraffin alone or paraffin to which stearic acid has been added.

Further, similar to step T120 in FIG. 2, a tubular member for forming the blood vessel portion 40 is prepared (step T520). Then, a solution of the polymer material prepared in step T500 and the paraffin melted in step T510 are mixed, and the blood vessel portion 40 is filled with the mixture (step T530). Then, by utilizing the difference in freezing point between the polymer material and paraffin, the polymer material and paraffin are cured (step T540), and the vascular lesion model 310 is completed.

For example, when agarose is used as the polymer material, in step T530, the aqueous agarose solution and molten paraffin are mixed and the blood vessel portion 40 is filled with the mixture. At this time, the aqueous agarose solution and the molten paraffin do not mix, and therefore, in step T530, the blood vessel portion 40 is filled with a mixed liquid in which the molten paraffin is dispersed in the form of fine particles in the aqueous agarose solution. Then, in step T540, agarose and paraffin are cured separately due to the difference in freezing point between agarose and paraffin, and the vascular lesion model 310 is obtained in which paraffin is precipitated in the agarose gel. Generally, paraffin has a higher freezing point than agarose, and thus fine particles of molten paraffin that are dispersed in the form of fine particles solidify and precipitate in an aqueous solution of agarose before gelation. After that, gelation of the aqueous agarose solution occurs.

According to such a configuration, similar to the second and third embodiments, the second lesion portion 330 formed using paraffin reflects ultrasonic waves due to the difference in acoustic impedance from the first lesion portion 20 arranged in contact with the second lesion portion 330, and thus the second lesion portion 330 is observed as being white in the ultrasonic image and simulates a calcified lesion in the ultrasonic image. In the fourth embodiment, the second lesion portion 330 is formed by fine particles of paraffin dispersed in the first lesion portion 20, because of which it is possible to adjust the appearance (whiteness of the image) of the second lesion portion 330 in the ultrasonic image depending on the amount of molten paraffin mixed with the solution of the polymer material in step T530.

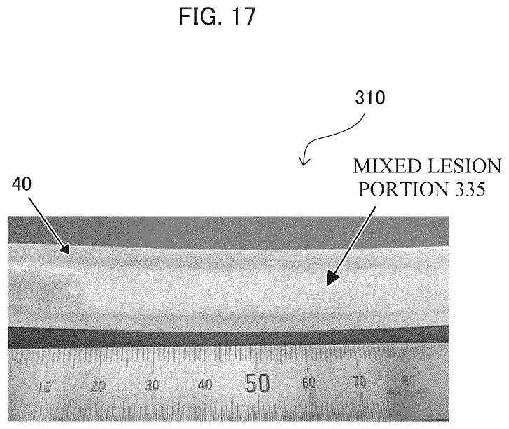

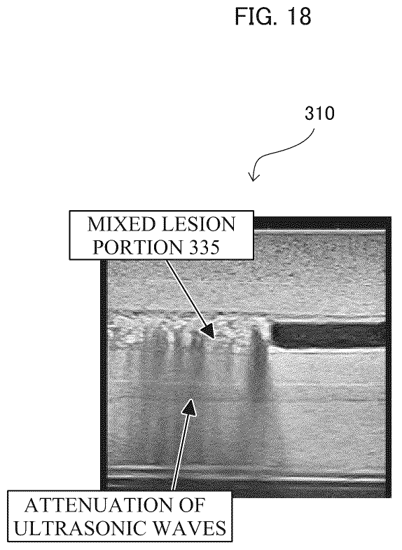

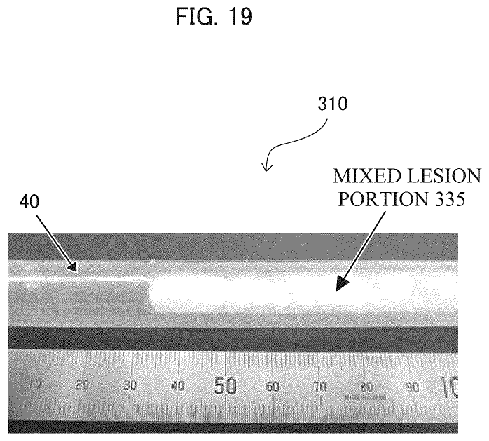

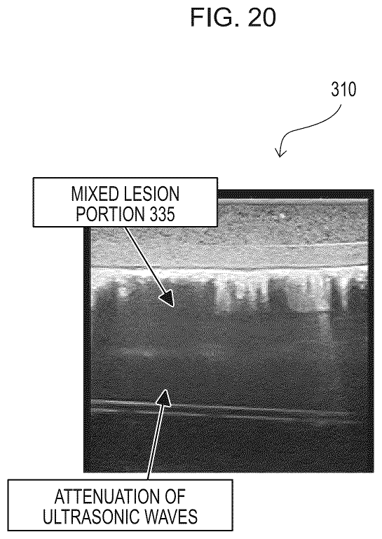

FIGS. 17 and 19 are explanatory views representing a photographed appearance of the vascular lesion model 310 manufactured by the method of manufacturing illustrated in FIG. 16. FIGS. 18 and 20 are explanatory views representing an ultrasonic image of the vascular lesion model 310 similar to FIGS. 17 and 19. Here, agarose gel mixed with cellulose nanofibers (CNF) is used as the polymer material forming the first lesion portion 20. FIGS. 17 and 18 are images of the vascular lesion model 310 manufactured by mixing molten paraffin at a rate of 15 wt % with respect to the aqueous agarose solution in step T530, and FIGS. 18 and 20 are images of the vascular lesion model 310 manufactured by mixing molten paraffin at a rate of 30 wt % with respect to the aqueous agarose solution in step T530. As shown in FIGS. 18 and 20, it was observed that paraffin fine particles dispersed in the agarose gel make the entire lesion portion whiter in the ultrasonic image, and that the lesser the amount of molten paraffin added, the lesser the attenuation of ultrasonic waves caused by the reflection of ultrasonic waves by paraffin.

It is noted that, in the case of a vascular lesion model in which the blood vessel portion 40 is constricted by the lesion portion, for example, after step T520 in FIG. 16, a core may be arranged in the blood vessel portion 40 similar to step T125 in FIG. 6, and after step T530, the core may be removed similar to step T145 in FIG. 6.

In FIG. 15, the second lesion portion 330 being fine particles of paraffin is dispersed in the first lesion portion 20 over the entire lesion portion, however, a different configuration may be used. For example, the blood vessel portion 40 may be filled with materials of the lesion portions so that a part filled only with a polymer material and a part filled with the polymer material mixed with molten paraffin are provided. Also, at least one type of the second lesion portion from the first to third embodiments may be further combined.

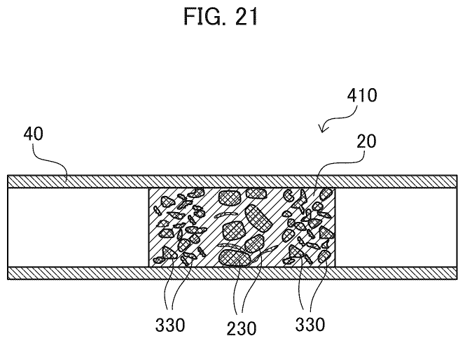

FIG. 21 is a cross-sectional view schematically illustrating an overall configuration of a vascular lesion model 410 as a variation of the fourth embodiment. The vascular lesion model 410 includes, in the first lesion portion 20, a site where the second lesion portion 330 of the fourth embodiment is arranged and a site where the second lesion portion 230 of the third embodiment is arranged. According to such a configuration, the second lesion portion 230 formed of paraffin flakes reflects ultrasonic waves to a greater extent than the second lesion portion 330 formed of paraffin fine particles, and is observed as a whiter ultrasonic image. In this way, by using a combination of different types of second lesion portions, the appearance (whiteness of the image) of the second lesion portion in the ultrasonic image, the hardness of the lesion portion that is related to the feeling when a medical device is inserted into the vascular lesion model, and the like can be freely changed for each site.

### E. Another Embodiment

The second lesion portion may be formed using a material other than calcium sulfate and paraffin. It is possible to use any material which has an acoustic impedance higher than that of the polymer material forming the first lesion portion 20, and which can form a second lesion portion simulating a calcified lesion portion in an ultrasonic image, by forming a part including a surface of the second lesion portion in contact with the first lesion portion 20. For example, the second lesion portion may be formed using an inorganic material such as glass or ceramic.

In the vascular lesion model of each of the above-described embodiments, the first and second lesion portions are arranged inside the blood vessel portion 40, but the vascular lesion model may have different configurations. The blood vessel portion 40 is not essential, and a vascular lesion model having the first lesion portion 20 and the second lesion portion without the blood vessel portion 40 may be provided for training including observation under ultrasound guidance.

The present disclosure is not limited to the above-described embodiments, and can be realized with various configurations without departing from the spirit of the present disclosure. For example, the technical features in the embodiments corresponding to the technical features in each of the aspects described in the SUMMARY may be appropriately replaced or combined to solve some or all of the problems described above, or to achieve some or all of the effects described above. Further, unless a technical feature is described as essential in the present specification, it may be omitted as appropriate.

### DESCRIPTION OF REFERENCE NUMERALS

10, 110, 210, 310, 410: Vascular lesion model
20: First lesion portion
130, 230, 330: Second lesion portion
40: Blood vessel portion
132: Granular portion
134: Coat layer
335: Mixed lesion portion

What is claimed is:

1. A vascular lesion model comprising:
a first lesion portion formed of a polymer material; and
a second lesion portion provided in contact with the first lesion portion and configured to simulate a calcified lesion in an ultrasonic image,
wherein a part of the second lesion portion includes a surface in contact with the first lesion portion, and is formed of a material having an acoustic impedance that is higher than an acoustic impedance of the first lesion portion.

2. The vascular lesion model according to claim 1, wherein
the second lesion portion includes calcium sulfate.

3. The vascular lesion model according to claim 2, wherein
the calcium sulfate is formed into granules.

4. The vascular lesion model according to claim 1, wherein
the second lesion portion includes paraffin.

5. The vascular lesion model according to claim 4, wherein
the second lesion portion includes granules of a polymer material coated with the paraffin.

6. The vascular lesion model according to claim 4, wherein
the paraffin is in the form of flakes.

7. The vascular lesion model according to claim 1, wherein
the polymer material is in the form of a hydrogel.

8. The vascular lesion model according to claim 2, wherein
the polymer material is in the form of a hydrogel.

9. The vascular lesion model according to claim 4, wherein
the polymer material is in the form of a hydrogel.

10. The vascular lesion model according to claim 7, wherein
the polymer material is a polysaccharide.

11. The vascular lesion model according to claim 8, wherein
the polymer material is a polysaccharide.

12. The vascular lesion model according to claim 9, wherein
the polymer material is a polysaccharide.

13. The vascular lesion model according to claim 10, wherein
the polysaccharide is agarose.

14. The vascular lesion model according to claim 11, wherein
the polysaccharide is agarose.

15. The vascular lesion model according to claim 12, wherein
the polysaccharide is agarose.

16. The vascular lesion model according to claim 1, further comprising:
a blood vessel portion having a tubular shape, wherein
the first lesion portion and the second lesion portion are arranged inside the blood vessel portion to constrict or occlude the blood vessel portion.

17. The vascular lesion model according to claim 2, further comprising:
a blood vessel portion having a tubular shape, wherein
the first lesion portion and the second lesion portion are arranged inside the blood vessel portion to constrict or occlude the blood vessel portion.

18. The vascular lesion model according to claim 4, further comprising:
a blood vessel portion having a tubular shape, wherein
the first lesion portion and the second lesion portion are arranged inside the blood vessel portion to constrict or occlude the blood vessel portion.

19. The vascular lesion model according to claim 7, further comprising:
a blood vessel portion having a tubular shape, wherein
the first lesion portion and the second lesion portion are arranged inside the blood vessel portion to constrict or occlude the blood vessel portion.
